(19) United States
(12) Patent Application Publication
(10) Pub. No.: US 2010/0079753 A1
(43) Pub. Date: Apr. 1, 2010

(54) RAMAN SPECTROMETER HAVING WAVELENGTH-SELECTIVE OPTICAL AMPLIFICATION

(75) Inventor: Markus P. Hehlen, Los Alamos, NM (US)

Correspondence Address: COCHRAN FREUND & YOUNG LLC, 2026 CARIBOU DR, SUITE 201, FORT COLLINS, CO, 80525, US

(73) Assignee: The Regents of the University of California, Oakland, CA (US)

(21) Appl. No.: 12/242,879

(22) Filed: Sep. 30, 2008

(51) Int. Cl. G01J 3/44

(52) U.S. Cl. 356/301

(57) ABSTRACT

An apparatus and method for obtaining Raman spectra that are suitable for continuous real-time monitoring, utilizing the basic technique of Raman spectroscopy in cooperation with wavelength-selective optical amplification are described. The invention improves the detection sensitivity of conventional Raman spectroscopy by orders of magnitude by providing strong wavelength-selective optical amplification and narrowband detection of the intense driving laser and the weak Raman signal(s), thereby essentially eliminating the driving laser signal from the detector and detection electronics. The invention is effective for both Stokes and anti-Stokes Raman lines, and either where the incident laser wavelength is fixed and the Raman spectrum is recorded by analyzing the output of the fiber amplifier with a spectrometer, or where the detection wavelength is fixed and the Raman spectrum is recorded by tuning the wavelength of the laser.

### STATEMENT REGARDING FEDERAL RIGHTS

This invention was made with government support under Contract No. DE-AC52-06NA25396 awarded by the U.S. Department of Energy. The government has certain rights in the invention.

### FIELD OF THE INVENTION

The present invention relates generally to Raman spectroscopy and, more particularly, to improving the sensitivity of Raman spectroscopic measurements by utilizing wavelength-selective optical amplification.

### BACKGROUND OF THE INVENTION

When laser light is incident on a molecule, it can give off part of its energy to excite characteristic vibrations of this molecule by a process known as Raman scattering. One result of this “inelastic” interaction is the appearance of red-shifted Raman lines in the spectrum that represent a characteristic “spectral fingerprint” of the molecule. Conventional Raman spectroscopy has two drawbacks that impede its applications in practical devices: (1) the interaction has a very small cross section (typically around 10⁻³⁰ cm²) such that only about one in 10¹⁰ to 10¹² of the incident photons undergoes Raman scattering; and (2) the energy transfer and thus the red-shift is usually quite small relative to the absolute energy of the incident laser, and a high-resolution spectrometer is needed to resolve the Raman lines of interest. Therefore, an extremely weak signal must be measured in the presence of a spectrally close and very intense laser line. As a result, conventional Raman spectroscopy measurements typically employ powerful lasers and bulky spectrometers, and the respective equipment tends to be expensive and non-portable.

Various strategies are being considered to enhance the Raman detection sensitivity: (1) in resonant Raman scattering the laser is tuned to or near an electronic resonance of the molecule in the UV to enhance the Raman scattering cross section; (2) in surface enhanced Raman spectroscopy (SERS) the Raman cross section is enhanced by binding the molecule onto a carefully engineered surface; and (3) in coherent anti-Stokes Raman spectroscopy (CARS) the Raman transition is driven coherently by two femto-second lasers to enhance the signal. These methods have drawbacks that limit their performance. The requirement of an engineered surface for SERS precludes the use of this technique for remote detection. CARS and derivative techniques have increased Raman efficiency by many orders of magnitude by employing several lasers to produce signals that interact coherently with each other, thereby substantially increasing the intensity of the Raman lines with a corresponding increase in the detection sensitivity; however, such techniques require several state-of-the-art femto-second lasers that are bulky, expensive, and not commercially available. Resonant Raman spectroscopy in the UV uses the enhancement of Raman lines near an electronic transition of the molecule; but, the technique typically suffers from the presence of undesirable sample fluorescence. Such fluorescence background can be reduced by the use of infrared lasers, although at infrared wavelengths the resonant enhancement is lost and the high-power lasers cause sample heating and degradation.

A wide range of physical and chemical methods are being investigated and developed to detect explosives residues on surfaces and explosives vapors around suspicious objects. Explosives detection in real-world environments is challenging because of the small sample quantities, the broad range of explosives compounds, the great variety in backgrounds, the short measurement times, the fact that targets are often moving, and the requirement that correct decisions must be made quickly. Additionally, explosive detection has to be performed at sufficiently safe distances: (a) 10 m for pedestrian suicide bombers; 50 m for improvised explosive devices (IEDs); and (b) 100 m and beyond for vehicle-based bombs.

Trace explosive materials can be detected by sensing either residual explosives particles or explosives vapors. Vapors are difficult to detect, especially at some distance, because the vapor pressures of common explosives are very low (between 10⁻⁶ and 10⁻¹² Torr at room temperature), and vapor release may be effectively suppressed by wrapping the explosive. Therefore, detection of explosives at a distance primarily employs the detection of residual particles on surfaces, further increasing the difficulty of using Raman spectroscopy.

### SUMMARY OF THE INVENTION

Accordingly, it is an object of the present invention to provide a Raman spectrometer having sufficient sensitivity to enable continuous, real-time monitoring.

Another object of the invention is to provide a Raman spectrometer that can be miniaturized.

Still another object of the invention is to provide a Raman spectrometer that builds on existing technology to reduce cost and increase reliability.

Yet another object of the invention is to provide a Raman spectrometer that is effective for rapid detection and identification of solid residues of explosives and other threat substances at distances between 10 and 100 m.

Additional objects, advantages and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

To achieve the foregoing and other objects, and in accordance with the purposes of the present invention, as embodied and broadly described herein, the apparatus for obtaining a Raman spectrum from a sample, hereof, includes in combination: a light source for producing photons impinging on the sample and having a first wavelength effective for generating Raman scattering photons having at least one second wavelength from the sample in response to the photons having a first wavelength; an optical amplifier for receiving photons from the sample and for selectively amplifying the photons having at least one second wavelength over the photons having a first wavelength; a detector for receiving the selectively amplified wavelengths from the optical amplifier and for generating a signal therefrom; and a signal processor for receiving the signal from the detector and for generating a Raman spectrum therefrom.

In another aspect of the invention, and in accordance with its objects and purposes, the method for obtaining a Raman spectrum from a sample, hereof, includes the steps of: producing photons impinging on the sample and having a first wavelength effective for generating Raman scattering photons having at least one second wavelength from the sample in response to the photons having a first wavelength; selectively optically amplifying the photons from the sample having at least one second wavelength over the photons having a first wavelength; generating a signal from the wavelengths produced from the step of selectively optically amplifying the photons from the sample; and generating a Raman spectrum from the signal.

In yet another aspect of the invention, and in accordance with its objects and purposes, the apparatus for obtaining a signal from a sample, hereof, includes in combination: a light source for producing photons impinging on the sample and having a first wavelength effective for generating fluorescence photons having at least one second wavelength from the sample in response to the photons having a first wavelength; an optical amplifier for receiving photons from the sample and for selectively amplifying the photons having at least one second wavelength over the photons having a first wavelength; a detector for receiving the selectively amplified wavelengths from the optical amplifier and for generating an electrical signal therefrom; and a signal processor for receiving the electric signal from the detector and for generating a signal therefrom.

In still another aspect of the invention, and in accordance with its objects and purposes, the method for obtaining a signal from a sample, hereof, includes the steps of: producing photons impinging on the sample and having a first wavelength effective for generating fluorescence photons having at least one second wavelength from the sample in response to the photons having a first wavelength; selectively optically amplifying the photons from the sample having at least one second wavelength over the photons having a first wavelength; generating an electrical signal from the wavelengths produced from the step of selectively optically amplifying the photons from the sample; and generating a signal from the electrical signal.

Benefits and advantages of the present Raman spectrometer having wavelength-selective optical amplification, over conventional and/or resonant Raman spectroscopy include, but are not limited to: (a) high detection sensitivity (Raman signals are enhanced by a factor of up to 10⁷, outperforming CARS, resonant Raman, or SERS and enabling low-power Raman spectroscopy in the infrared); (b) compact volume similar to a laptop computer since there is no need for a monochromator, thereby enabling truly portable endospore monitors that can be inconspicuously located in high-profile areas or deployed to troops; (c) low cost since many of the components are being manufactured in high volumes for fiber-optic telecommunications applications; (d) no fluorescence background if the tunable laser is operated in the infrared, therefore, sample fluorescence is not excited; (e) low-power operation (at a 50 m distance, only 20 mW of CW laser power on target is required, reducing sample heating/degradation and making it possible to operate the entire apparatus on battery power; (f) the 1.3 μm laser wavelength allows for clandestine target illumination, substantially eye-safe scanning of human targets, and low interference with atmospheric water; (g) high reliability since the present components rely on mature technology that has been qualified for fiber-optic telecommunications applications having low failure-in-time (FIT) rates; and (h) short time to market which is attractive for Federal, State, and Local Governments which are currently facing a vulnerability in the area of terrorism using chemical, biological and explosive substances.

### BRIEF DESCRIPTION OF THE DRAWINGS

The accompanying drawings, which are incorporated in and form a part of the specification, illustrate the embodiments of the present invention and, together with the description, serve to explain the principles of the invention. In the drawings:

FIGS. 1A through 1D illustrate optical amplification of weak Raman signals and suppression of residual laser light by wavelength-selective optical amplification in accordance with the method of the present invention: FIG. 1A is a graph of the intensity of incident laser radiation as a function of wavelength; FIG. 1B is a graph of the intensity of the incident laser radiation shown in FIG. 1A, and the resulting weak Raman signal as a function of wavelength; FIG. 1C is a graph of the intensity of the incident laser radiation and weak Raman signal, and selective amplification of the Raman signal as a function of wavelength; and FIG. 1D is a graph of the intensity of the narrowband (selective) detection of the amplified Raman signal as a function of wavelength.

FIG. 2 is a block schematic representation of one embodiment of the Raman spectrometer of the present invention using wavelength-selective optical amplification.

FIG. 3 is a schematic representation of an embodiment of the Raman spectrometer of the present invention using wavelength-selective optical amplification by means of a fiber-optic amplifier for a stationary sample.

FIG. 4 is a schematic representation of an embodiment of the Raman spectrometer of the present invention using wavelength-selective optical amplification similar to that described in FIG. 3 hereof for a moving sample.

FIG. 5 is a schematic representation of a remote detection embodiment of the Raman spectrometer of the present invention using wavelength-selective optical amplification utilizing the principles of operation shown in FIGS. 1 and 2, hereof in a fiber-optic embodiment of the invention.

FIG. 6A illustrates a fixed-wavelength laser producing a Raman spectrum that is recorded by scanning it with an optical spectrum analyzer (OSA), while FIG. 6B shows that the same spectrum can be recorded by fixing the detection wavelength and scanning the wavelength of the laser.

FIG. 7 is a schematic representation of an erbium-doped fiber amplifier (EDFA), where the erbium-doped fiber is excited by two counter-propagating 980-nm pumps that are launched into the fiber by means of couplers, the gain medium being placed between two optical isolators to prevent lasing by suppressing back-reflections from the fiber ends, a saturating-tone laser set to a wavelength within the EDFA gain spectrum such as to not interfere with the Raman measurement being used to stabilize the amplifier.

### DETAILED DESCRIPTION OF THE INVENTION

Briefly, the present invention includes an apparatus and method for obtaining Raman spectra that are suitable for continuous real-time monitoring, utilizing the basic technique of Raman spectroscopy in cooperation with wavelength-selective optical amplification. The present apparatus lends itself to miniaturization to enable portability, and relies on existing off-the-shelf components and mature fiber-optic and laser technology to reduce cost and increase reliability. The invention improves the detection sensitivity of conventional Raman spectroscopy by orders of magnitude by utilizing wavelength-selective optical amplification. It is expected that the detection sensitivity is such that the apparatus of the present invention may be used for the rapid detection and identification of solid residues of explosives at remote distances up to 100 m, for real-time monitoring of airborne endospores such as anthrax, and for monitoring a variety of target molecules that have characteristic Raman lines. Another broad application field is the continuous monitoring of exhaust gases in industry. The apparatus is capable of monitoring several species in sequence by tuning an incident laser to the respective characteristic wavelength. A single real-time continuous monitor could therefore replace a suite of specific gas sensors in these applications.

The invention is general and is believed by the inventor to establish a new Raman spectroscopic technique, that of an optical amplifier providing strong wavelength-selective optical amplification and narrowband detection of the intense excitation laser and the weak Raman signal(s). The excitation laser signal is thereby essentially eliminated from the detection electronics. The invention is effective for both Stokes (scattering with energy loss) and anti-Stokes (scattering with energy gain) Raman lines but is more effectively employed for the more intense Stokes Raman lines.

An example of a specific implementation of the present invention might include a real-time, portable optical monitor for airborne endospores such as anthrax. It is well known that up to 10-15% of the weight of endospores consists of dipicolinic acid (DPA), a compound unique to bacterial spores. While the presence of DPA is not an indicator for a specific endospore, it is a good indicator for the potential presence of a harmful airborne endospore. A Raman spectroscopic line between about 970 cm⁻¹ and about 1000 cm⁻¹ corresponding to the totally symmetric stretching vibration of the pyridine ring in DPA has been used as a marker for this species. A real-time monitor for DPA can therefore be utilized for continuous air sampling in a first stage of a bioagent detection system. If the monitor detects the presence of DPA, a specific test can be carried out on that sample in a second step to verify the “positive” as well as identify the exact nature of the endospore. In this way, time-consuming endospore-specific assays have to be made only when the monitor triggers a DPA alarm.

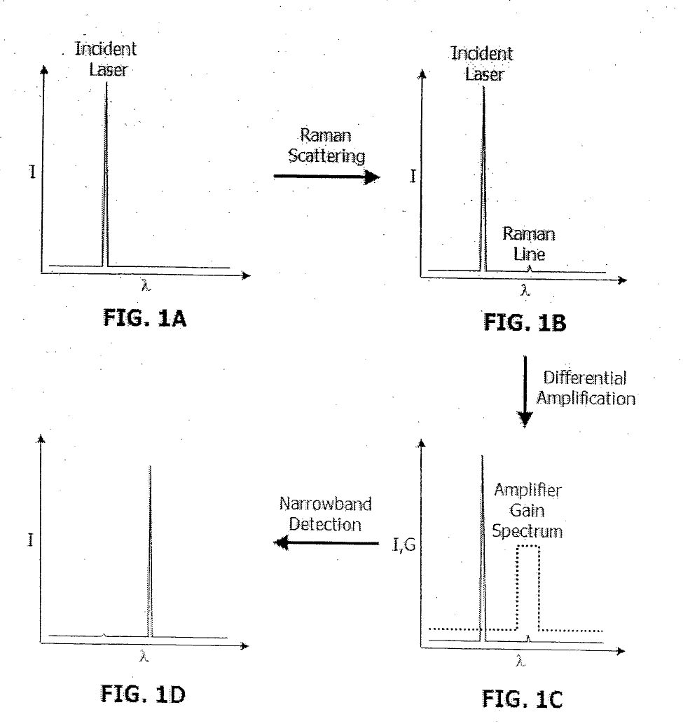

Reference will now be made in detail to the present embodiments of the invention, examples of which are illustrated in the accompanying drawings. In the Figures, similar structure will be identified using identical reference characters. Turning now to FIGS. 1A through 1D, there is schematically illustrated the optical amplification of weak Raman signals and suppression of residual laser light by wavelength-selective optical amplification in accordance with the method of the present invention. A laser (FIG. 1A) interacts with a molecule by Raman scattering, giving rise to a red-shifted very weak Raman line (for the case of Stokes Raman scattering) (FIG. 1B). This spectrum is directed into an optical amplifier whose gain peaks at the wavelength of the Raman line and whose gain is negligible (or even negative; that is, a loss) at the wavelength of the excitation laser line, as indicated by the dotted optical amplifier gain curve in FIG. 1C. As a result: (1) the Raman line intensity is amplified substantially on an absolute scale by the optical amplifier; and (2) the intensity ratio of Raman signal to residual laser light is increased dramatically, and the Raman line can now be detected with very good signal-to-noise ratio (FIG. 1D) with simple optical components.

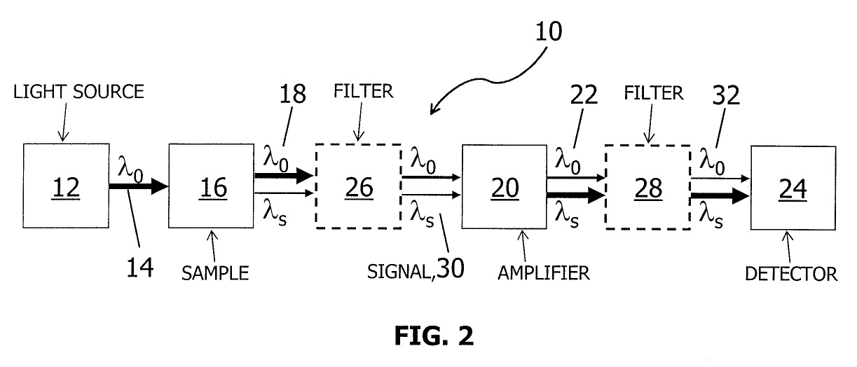

FIG. 2 is a block diagram schematically illustrating the components of one embodiment of apparatus, 10, of the present invention. Monochromatic light source, 12, such as a laser, as an example, having wavelength λ₀, 14, is incident on sample, 16. Raman scattering in sample 16 creates Stokes and Anti-Stokes optical signals. The signal light, together with residual laser light, 18, is directed into optical amplifier, 20, having optical gain at the signal wavelength λₛ, 30, of interest which is substantially greater than the optical gain for the laser wavelength λ₀, 22. This generates a wavelength-selective optical amplification in which: (1) the signal intensity at λₛ is increased; and (2) the ratio of signal intensity at λₛ versus residual laser intensity at λ₀ is enhanced. The sensitivity of apparatus 10 for detecting the signal at λₛ in the presence of the laser at λ₀ is thereby significantly improved. Signal 30 at λₛ is subsequently detected by detector, 24. Bandpass filters, 26, and 28, having large transmission at the signal wavelength λₛ and small transmission at other wavelengths, may be utilized before and/or after optical amplifier 20 to enhance the wavelength-selectivity provided by optical amplifier 20.

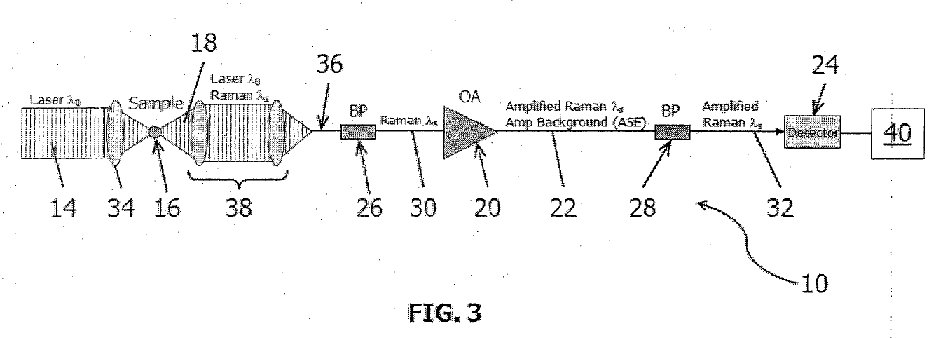

FIG. 3 is a schematic representation of Raman spectrometer 10 further illustrating wavelength-selective optical amplification utilizing the principles of operation shown in FIGS. 1 and 2, hereof, in a fiber-optic embodiment of the invention. Laser light 14 is focused onto sample 16 by focusing optics, 34, as required by the specific application, and the Raman signal, together with the residual laser light, 18 are collected and coupled into an optical fiber, 36, by collection optics, 38. It should be mentioned that for some embodiments of the present invention, sample 16 may be located close to or actually on the end surface of fiber 36. Narrow band-pass filter (BP) 26 having a transmission centered at wavelength λₛ and having a spectral bandwidth δλ rejects background outside λₛ±δλ. The light is then launched into low-noise fiber-optic amplifier (OA) 20. The wavelength λ₀ of the incident laser light is chosen such that the wavelength λₛ of the Raman line of interest ideally coincides with the gain peak of the optical amplifier, and the OA has no gain (or even loss) at λ₀. The apparatus may be tuned to a different Raman line by simply tuning the incident laser wavelength λ₀ while leaving the detection side of the apparatus unchanged; that is, the detection side is fixed and optimized for the wavelength λₛ. Narrow band-pass filter (BP) 28 at the output of OA 20 rejects background outside λₛ ±δλ that may be present from residual laser light as well as amplified spontaneous emission (ASE), and it transmits the amplified Raman signal. The amplified Raman signal 32 is subsequently detected by photodiode or a photo-multiplier tube 24 and further processed by signal processor, 40. Several OA/BP stages can be arranged in series in order to optimize the amplification for a chosen application.

It may be possible to use fluorescence of target 16 as a characteristic signature of the substance to be detected. Wavelength-selective optical amplification can be employed in this case to detect weak sample fluorescence at large distances. In this case, laser wavelength 14 is tuned to a wavelength that produces a fluorescence response from target 16. The fluorescence photons are collected by collection optics 56 and amplified by fiber-optic amplifier 20 that is designed to provide optical gain at the wavelength of sample fluorescence. Amplified fluorescence is detected by phototube 24 and further processed by signal processor 40.

Although FIG. 3 is an embodiment utilizing fiber-optics on the detection side of apparatus 10, Raman spectroscopy with wavelength-selective optical amplification can be implemented using bulk optics. However, the device size is expected to be much less attractive for a bulk-optic embodiment. It should be noted that the sensitivity of Raman spectrometer 10 can be further improved by utilizing well-known amplitude or frequency modulation techniques of the incident laser 12. For example, high-frequency (with respect to amplifier dynamics) modulation of the amplitude of the incident laser and phase-sensitive detection of the first or higher-order harmonics in the detector signal may be employed to suppress the non-modulated undesired background.

Erbium-doped fiber amplifiers (EDFA) are deployed worldwide in 1.5 μm long-haul fiber-optic telecommunication networks, as an example, and EDFA technology is well understood, reliable, and the respective components are low in cost. EDFAs typically provide low-noise optical amplification in range between about 1530 nm and about 1565 nm in the near infrared. The DPA Raman line mentioned hereinabove can be favorably positioned at the EDFA gain peak of around 1535 nm by tuning the incident laser to 1335 nm, that is, to about 1000 cm⁻¹ higher energy. The 1.3 μm wavelength range finds extensive use in many short-range fiber-optic networks, and a variety of reliable low-cost components, such as the incident source laser mentioned in FIG. 3, are therefore commercially available.

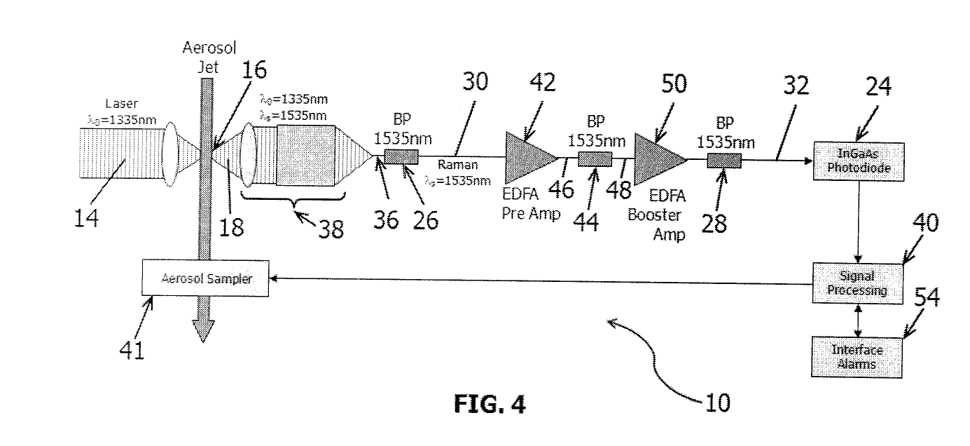

FIG. 4 shows a schematic representation of an embodiment of the present invention expected to be effective as a portable, real-time monitor for airborne endospores, such as anthrax. Laser light 14 at 1335 nm is provided by a fixed-wavelength or tunable semiconductor diode laser 12 (such as Velocity 6324 by New Focus Corporation, San Jose Calif.). Sample 16 is shown as an aerosol jet which is directed into aerosol sampler, 41, for further analysis should a Raman signal of interest be detected. Laser and Raman wavelengths 18 are coupled to single=mode silica fiber 36 using gradient index (GRIN) lens 38. Narrow-band, band-pass filter centered at 1535 nm (such as 100 GOADM filter from Oplink Communications, Fremont, Calif.) 26 further rejects residual laser light and transmits Raman signal 30 with low loss. First EDFA stage, 42, is configured as a pre-amplifier to provide optical amplification with minimal noise figure. Second narrow-band, band-pass filter, 44, which may be identical to filter 26, further rejects residual laser light and suppresses broad-band amplified spontaneous emission (ASE) emanating, 46, from first EDFA 42. The light emerging, 48, from filter 44 is directed into second EDFA stage, 50, configured as a booster amplifier to provide maximum signal power amplification. Third narrow-band, band-pass filter, 28, rejects residual laser light and ASE. Amplified and filtered signal light 32 is subsequently detected by photodiode (such as an avalanche photodiode or an InGaAs photodiode such as model 2053 from New Focus Inc., San Jose, Calif.) 24. The electrical signal therefrom is further processed by signal processor 40 and can, for example, trigger alarms, 54, or actively control real-time aerosol sampler 41.

It is estimated that the configuration shown in FIG. 4 can increase the Raman line intensity by a factor of 10⁶ to 10⁸ while suppressing the residual laser light by a factor of ˜10⁸. Initial calculations indicate that the real-time detection of several dozen endospore “clumps” (each clump containing ˜100-200 spores in airborne/weaponized anthrax) in an air sampler should be possible. This detection limit is well below the typical threshold of ˜50,000 spores needed to infect a human.

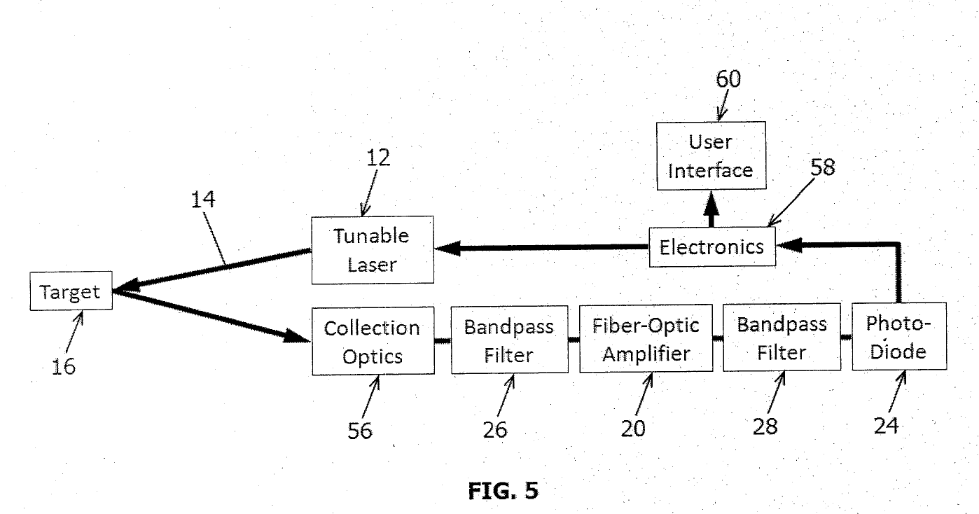

FIG. 5 is a schematic block representation of a remote detection embodiment of the Raman spectrometer of the present invention having wavelength-selective optical amplification utilizing the principles of operation shown in FIGS. 1 and 2, hereof in a fiber-optic embodiment of the invention. Tunable laser 12, such as a semiconductor laser, illuminates remote target 16 and the Raman-scattered light is remotely detected using collection optics, 56, fiber-optic amplifier 20 and photodiode 24 with a similar apparatus to that described in FIGS. 3 and 4 hereof. The detection system may be adjusted to a fixed wavelength using spectrally narrow bandpass filters 26 and 28. The Raman spectrum is recorded by scanning the laser wavelength 14 generated by laser 12 using electronics, 58. User interface, 60, may include a display or an alarm system, as examples. The apparatus described in FIG. 5 is clearly also suited for the analysis of samples at close range.

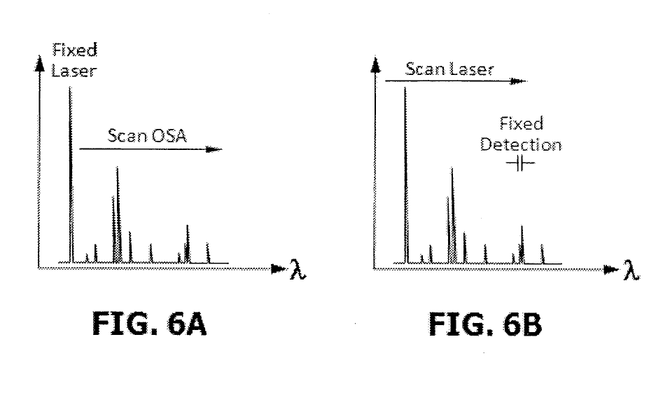

FIG. 6A illustrates a common first method for recording a Raman spectrum, wherein the incident laser wavelength is fixed and the Raman spectrum is recorded by analyzing the output of the fiber amplifier with a spectrometer. FIG. 6B describes a method where the detection wavelength is fixed and the Raman spectrum is recorded by tuning the wavelength of the laser. Both methods yield the equivalent Raman spectrum, and both can be performed by the apparatus and method of the present invention. The methods differ in terms of system implementation, performance, size, power consumption, and cost, tradeoffs which are application dependent and will be discussed hereinbelow.

Turning in more detail to the fiber-optic amplifier, such optical amplifier amplify an incoming optical signal directly without first converting it to an electrical signal. An optical amplifier can be viewed as a laser without a cavity since it amplifies an incoming optical signal by stimulated emission in the amplifier's gain medium, which is a doped fiber in case of a fiber amplifier. Erbium-doped fiber amplifiers (EDFA) are the most common of fiber amplifiers since their wavelengths of optical gain overlap with the transmission window of silica fiber (approximately 1.5 μm). They offer outstanding amplification and noise performance, and all high-capacity fiber-optic telecommunication networks are built using EDFAs.

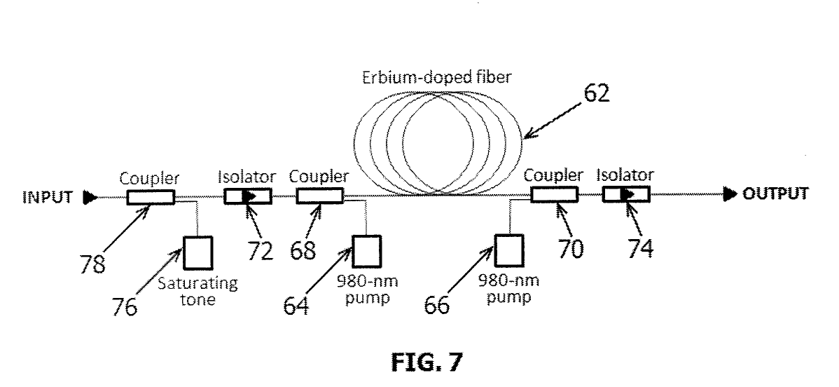

The basic architecture of an EDFA is illustrated in FIG. 7 hereof. It consists of erbium-doped silica optical fiber, 62, pumped by counter progagating semiconductor diode lasers, 64, and 66, through couplers, 68, and 70, respectively. Pumping can be implemented at 980 nm for minimal amplifier noise or at 1480 nm for maximum amplifier output power. The pump laser excites the erbium ions from the ⁴I_{15/2} ground state to the ⁴I_{13/2} excited state from where they decay back to the ⁴I_{15/2} ground state by either spontaneous or stimulated emission of photons in the 1450 nm-1620 nm wavelength range. The quantum yield of the ⁴I_{13/2} excited state is near 100%. Instead of an erbium-doped fiber, the gain medium can also consist of an erbium-doped channel waveguide in a planar material. The gain medium is placed between two optical isolators, 72, and 74, to prevent lasing by suppressing back-reflections from the fiber ends. The EDFA gain spectrum typically peaks around 1530 nm where optical gains of up to 40 dB (factor of 10⁴) are possible for small signals. As shown in FIG. 4, hereof, two EDFAs are often used in a sequence of a pre-amplifier 42 and a booster amplifier 50, each optimized for optical power and noise performance. Small-signal gains of up to 70 dB (factor of 10⁷) at 1530 nm are possible from such 2-stage EDFAs.

Excited erbium ions can decay by both spontaneous and stimulated emission. The spontaneously emitted photons are amplified by stimulated emission in the gain medium much like input signals. This effect is known as Amplified Spontaneous Emission (ASE), and it determines the noise performance of the amplifier. ASE also causes a spectrally broad output in the case where no input signals are provided. This effect is undesired as it can interfere with measuring the amplified Raman signals in the present apparatus. A common and straightforward way to reduce such excessive ASE is to use a “saturating tone”, which is a continuous-wave (CW) laser, 76, tuned to a wavelength within the gain spectrum and launched into the gain medium using coupler, 78, to stabilize the ratio of spontaneous and stimulated emission.

As stated hereinabove, the present Raman spectrometer uses a fiber amplifier to amplify the collected weak Raman signals. The wavelengths of the Raman signals, therefore, must fall within the wavelength range of optical gain in the amplifier which is specific to the type of fiber amplifier, in order for amplification to occur. In the case of EDFAs, optical gain typically occurs in the range of approximately 1525-1610 nm, which corresponds to an energy span of 346 cm⁻¹. For explosives detection, as an example, the spectrum should cover the Raman energies of 500-1600 cm⁻¹ to encompass the “finger-print” transitions that are important for the identification of common explosives. The corresponding energy span of 1100 cm⁻¹ exceeds the 346 cm⁻¹ energy span of optical gain in the EDFA. It is therefore not possible (as shown in FIG. 6A) to choose the laser wavelength such that the entire Raman spectrum falls in the gain region of the fiber amplifier. Explosives detection therefore favors the alternative strategy shown in FIG. 6B that uses a fixed detection wavelength in conjunction with a tunable laser.

Fixed wavelength detection is advantageous for the optimization of system performance since it allows placement of the detection window at the wavelength of maximum optical gain in the amplifier. This is achieved by placing the amplifier between two identical, spectrally narrow bandpass filters. Assume that the center of the bandpass filter is selected to be λₛ and the bandpass filter has a spectral bandwidth of δλ. The EDFA only provides amplification in the range λₛ±δλ. Incoming optical signals that fall outside of this window, such as other Raman lines and the laser excitation wavelength, will experience strong attenuation. As the tunable laser is scanned, the corresponding Raman lines are scanned across the λₛ±δλ window, and a Raman spectrum can be recorded by means of a photo-detector at the EDFA output. The spectral bandwidth δλ of the bandpass filter determines the spectral resolution of the Raman spectrum. Spectrally narrow fiber-optic bandpass filters for the EDFA wavelength range are commercially available at low cost from the optical telecommunications industry. This component is also known as Optical Add-Drop Multiplexer (OADM) and is used to add or drop individual wavelength channels in fiber-optic telecommunications networks. The OADM center wavelengths are standardized by the International Telecommunication Union (ITU), and components world-wide are manufactured with tight tolerances to the ITU channel grid. The present Raman spectrometer exploits this mature technology base to reproducibly position a narrow detection window at the desired wavelength. Spectral bandwidths of 0.5 nm (˜2 cm⁻¹ at 1.5 μm) and low loss (<0.8 db) are readily achievable with low-cost commercial OADMs.

For some applications it may be possible to position the region of Raman energies of interest entirely within the gain spectrum of the optical amplifier. In such a situation, it is possible to record the amplified Raman spectrum by analyzing the output of the optical amplifier using an optical spectrum analyzer (OSA) including a monochromator and a photodetector. The amplification of the Raman signals and the suppression of residual laser light provided by the optical amplifier preceding the OSA makes possible the use of a simpler and less bulky OSA than that typically used in traditional Raman spectroscopy.

The foregoing description of the invention has been presented for purposes of illustration and description and is not intended to be exhaustive or to limit the invention to the precise form disclosed, and obviously many modifications and variations are possible in light of the above teaching. The embodiments were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

1. An apparatus for obtaining a Raman spectrum from a sample, comprising in combination:
a light source for producing photons impinging on said sample and having a first wavelength effective for generating Raman scattering photons having at least one second wavelength from said sample in response to the photons having a first wavelength;
a solid fiber optical amplifier for receiving photons from said sample and for selectively amplifying the photons having at least one second wavelength over the photons having a first wavelength;
a detector for receiving the selectively amplified wavelengths from said optical amplifier and for generating a signal therefrom; and
a signal processor for receiving the signal from said detector and for generating a Raman spectrum therefrom.

2. The apparatus of claim 1, further comprising a first bandpass filter disposed between said sample and said optical amplifier, for receiving photons from said sample and having a large transmission for photons having at least one second wavelength and a small transmission for all other wavelengths, whereby photons transmitted by said first bandpass filter are received by said optical amplifier.

3. The apparatus of claim 1, further comprising a second bandpass filter disposed between said optical amplifier and said detector, for receiving photons from said optical amplifier, and having a large transmission for photons having at least one second wavelength and a small transmission for all other wavelengths, whereby photons transmitted by said second bandpass filter are received by said detector.

4. The apparatus of claim 1, wherein the wavelength of the photons having a first wavelength from said light source is varied over a chosen range such that a Raman spectrum is generated.

5. The apparatus of claim 1, wherein the wavelength of the photons from said light source having a first wavelength is fixed, and wherein the wavelength of selective amplification of the photons having at least one second wavelength over the photons having a first wavelength is varied over a chosen range such that a Raman spectrum is generated.

6. The apparatus of claim 1, wherein said optical amplifier comprises an erbium-doped fiber amplifier.

7. The apparatus of claim 1, further comprising a gradient index lens for coupling photons emitted from said sample into said optical amplifier.

8. The apparatus of claim 1, wherein said sample is a flowing sample.

9. The apparatus of claim 1, wherein said sample is remote from optical amplifier.

10. A method for obtaining a Raman spectrum from a sample, comprising the steps of:
producing photons impinging on the sample and having a first wavelength effective for generating Raman scattering photons having at least one second wavelength from the sample in response to the photons having a first wavelength;
selectively optically amplifying the photons from the sample having at least one second wavelength over the photons having a first wavelength using a solid fiber optical amplifier;
generating a signal from the wavelengths produced from said step of selectively optically amplifying the photons from the sample; and
generating a Raman spectrum from the signal.

11. The method of claim 10, further comprising the step of passing the photons from the sample through a bandpass filter having a large transmission for photons having at least one second wavelength and a small transmission for all other wavelengths before said step of selectively optically amplifying the photons.

12. The method of claim 10, further comprising the step of passing photons from said step of selectively optically amplifying the photons from the sample through a bandpass filter having a large transmission for photons having at least one second wavelength and a small transmission for all other wavelengths, before said step of generating a signal from the wavelengths produced from said step of selectively amplifying the photons from the sample.

13. The method of claim 10, further comprising the step of varying the wavelength of the photons having a first wavelength over a chosen range from said step of producing photons such that a Raman spectrum is generated.

14. The method of claim 10, further comprising the step of varying the wavelength of selective amplification of the photons having at least one second wavelength over the photons having a first wavelength over a chosen range in said step of selectively amplifying the photons from the sample, such that a Raman spectrum is generated.

15. (canceled)

16. The method of claim 10, wherein the optical amplifier comprises an erbium-doped fiber amplifier.

17. The method of claim 10, wherein the sample is a flowing sample.

18. The method of claim 10, wherein the sample is remote from the optical amplifier.

19. An apparatus for obtaining a signal from a sample, comprising in combination:
a light source for producing photons impinging on said sample and having a first wavelength effective for generating fluorescence photons having at least one second wavelength from said sample in response to the photons having a first wavelength;
a solid fiber optical amplifier for receiving photons from said sample and for selectively amplifying the photons having at least one second wavelength over the photons having a first wavelength;
a detector for receiving the selectively amplified wavelengths from said optical amplifier and for generating an electrical signal therefrom; and
a signal processor for receiving the electric signal from said detector and for generating a signal therefrom.

20. A method for obtaining a signal from a sample, comprising the steps of:
producing photons impinging on the sample and having a first wavelength effective for generating fluorescence photons having at least one second wavelength from the sample in response to the photons having a first wavelength;
selectively optically amplifying the photons from the sample having at least one second wavelength over the photons having a first wavelength using a solid fiber optical amplifier;
generating an electrical signal from the wavelengths produced from said step of selectively optically amplifying the photons from the sample; and
generating a signal from the electrical signal.
